(19) United States
(12) Patent Application Publication
(10) Pub. No.: US 2018/0029239 A1
(43) Pub. Date: Feb. 1, 2018

(54) Robot System

(71) Applicant: KUKA Roboter GmbH, Augsburg (DE)

(72) Inventors: Robert FODOR, Augsburg (DE); Cyrill VON TIESENHAUSEN, Augsburg (DE)

(21) Appl. No.: 15/549,414

(22) PCT Filed: Feb. 4, 2016
(86) PCT No.: PCT/EP2016/000190

§ 371 Date: Aug. 8, 2017

(30) Foreign Application Priority Data
Feb. 9, 2015 (DE) 10 2015 001 624.5

(51) Int. Cl. B25J 19/00

(52) U.S. Cl. CPC B25J 19/0029

(57) ABSTRACT

The invention relates to a robot system comprising (I) a robot (100) for guiding an application part (300). The robot (100) has the following: (a) a robot arm (110) with a base (112), a region (114) which is proximal to the base (112), a region (116) which is distal to the base (112), and a securing device (130) for securing the application part (300), in particular in a removable manner, said securing device (130) being arranged in the distal region (116); b) a grounding (180); and (c) a cable (200) for connecting to the application part (300) and to a control device (500), in particular in a removable manner, comprising at least one signal line (250) and/or at least one energy supply line (240), a protection conductor (230), a distal connection means (140) for electrically connecting the application part (300) to the cable (200), in particular in a removable manner, and a proximal connection means (150) for electrically connecting the control device (500) to the cable (200), in particular in a removable manner; and (II) an adapter (400) which has an electric line for (410) for electrically connecting the protection conductor (230) of the cable (200) to the grounding (180) of the robot (100), in particular in a removable manner. The invention further relates to a method for producing a robot system of the aforementioned type and to a use of a robot system of the aforementioned type.

The present disclosure relates to a robot system, as well as to a method for producing such a robot system and a use of such a robot system.

End effectors of robots are often not purchased from the manufacturer of the robot, but are instead produced, for example, in the user's company or by specialized suppliers. As a result, the robot manufacturer often does not know what functionalities are to be provided with the aid of the robot. For this reason, the robot manufacturer includes a mounting device for the end effector, as well as signal and/or power supply lines, usually on or in the robot, which are used to guide or operate the end effector.

In medical technology in particular, there are specific requirements for the wiring of the end effector depending on the application; in this technical field, the end effector is also referred to as the application part. For the applications, a distinction is made between those in which the application part must be grounded, and those in which the application part may not be grounded.

In order to cover both applications, it has hitherto generally been necessary for a robot manufacturer to carry two separate types of robot in their range of products. Such robot systems can furthermore typically not, or only with a great deal of effort, be converted from the one to the other application; for example, by partially disassembling the robot system and pulling a new cable in.

One object of one version of the present invention is to provide an improved robot system, which in particular allows robot production and/or conversion of the robot system from one to the other application to be simplified.

This object is achieved by a robot system with the features of claim 1. Claim 13 places the use of a robot system as described herein under protection and claim 14 places a method for producing a robot system as described herein under protection. Advantageous embodiments of the invention are the subject matter of the subclaims.

According to one aspect of the present invention, a robot system comprises: (I) a robot for guiding an application part, wherein said robot comprises a robot arm with a base, an area that is proximal to the base, an area that is distal to the base and a mounting device for the, in particular detachable mounting of the application part, wherein the mounting device is disposed in the distal area, a grounding and a cable for the, in particular detachable, connection to the application part and a control unit with at least one signal line and/or at least one power supply line, a protective conductor, a distal connecting means for the electrical, in particular detachable, connection of the application part to the cable and a proximal connecting means for the electrical, in particular detachable, connection of the control unit to the cable; and (II) an adapter comprising an electrical line for the electrical, in particular detachable connection of the protective conductor of the cable to the grounding of the robot.

In one design, the robot is a jointed arm robot with a plurality of axes, in particular with at least five, six or seven axes. In one design, this robot configuration has the advantage that robots of this type can operate in a confined space. This is particularly important when robots have to work together with other equipment or people in limited space, such as, for example, in the field of medicine, in particular surgery, where several robots and/or one robot and several people are working around an operating table. Furthermore, in one design, these jointed arm robots require only a very small assembly surface, which allows them to be mounted on the floor, on the wall, on the ceiling or on a rail system on the floor, wall or ceiling.

Starting from the base, which is in particular the assembly surface, a proximal and a distal area of the robot arm is defined. For a floor-mounted and upwardly facing robot system, the proximal area is the lower area of the robot arm, i.e. the area near the base or the floor. In this perspective, the distal area is the area at the upper end of the robot arm, where the application part, or at least a mounting device for attaching an application part, is ordinarily provided.

The application part can be any type of manipulator and/or sensor. In particular the application part can be a gripper, a lifting element, a support element, a joining device, a separating device, a sensor device and, in particular, a medical device. These include, in particular, application parts for minimally invasive surgery or for open-heart surgery, such as scissors, cameras, probes, knives, clamping devices or devices for wound closure, defibrillators, laser, suction devices, grippers and the like. The application part is in particular an electric, in particular electronic device, which can be connected, in particular is connected to a control unit, and can be supplied, in particular is supplied by said control device with instructions and/or power, and/or transfers data, in particular measurement or video data, to said control unit, or is set up or provided to do so. The application part is, in particular mechanically, held in the distal area of the robot arm via the mounting device, and guided by said mounting device. The connection between the mounting device and the application part can be designed to be detachable or non-detachable. The application part is in particular a separately produced component that, in a further development, is not also controlled via a robot control unit. The later applications are often not known to the manufacturer of the robot systems. According to one design, the application part therefore comprises a control unit that is independent of the robot control unit, wherein the two last-mentioned elements are arranged within the framework of the human-machine interface, which is in particular provided by the manufacturers of the application parts, and jointly addressed by one operator.

Grounding refers to an electrically conductive connection of the robot system with the ground, or with a potential which, at least substantially, corresponds to the ground. The intent is in particular to provide a reference potential, which can be used when required as a reference value, and also to prevent static charging of the robot and to provide a protective mechanism in the event of a faulty electric circuit in the robot. Among other things, therefore, in particular the housing of the robot is grounded to prevent an operator standing nearby, and/or, in the case of medical technology, a patient, from receiving an electric shock. In general, this grounding is especially useful to the robot during normal operation for the purpose of safely dissipating uncontrollably occurring current flows, which result from static charging. In one design, the grounding is a component of the robot, in particular of the robot arm.

As explained above, the manufacturer of the robot often does not know which application the robot he provides will ultimately be used for. For this reason, a cable is provided on or in the robot, which allows the manufacturer of the application part to supply and/or control and/or analyze data, and which, in one design, is not used by the other components of the robot. In accordance with one design, the application part is connected to the control unit by means of this cable, via at least one signal line and/or at least one power line. In this case, the term “line” says nothing about the type, number and configuration of the respectively provided conduits. A line may consequently contain one, two, three or more conduits. The conduits may contain copper, aluminum or other current-carrying metals and/or alloys, as well as glass and/or plastic materials to transmit light waves, for example.

According to one design, the application part is supplied only with power via the cable, while the data is transferred wirelessly.

According to another design, only data is exchanged with the application part via the cable, and the application part is equipped with its own power source, in particular a battery, or a separate power connection.

The cable comprises a protective conductor, which in one design is realized in the form of a shielding that surrounds the internal signal and/or power supply lines. According to one design, this shielding comprises a metal-containing film and/or a mesh of metal-containing wire that encloses the signal and/or power supply lines in order to shield said lines from interference in the form of electromagnetic fields, which occur, for example, in the vicinity of electric motors, as are, in particular, used to move the robot arm.

According to one design, the cable is provided at least at its ends with connecting means. In accordance with the above definitions, the cable in particular comprises a proximal connecting means near the base, and a distal connecting means near the mounting means for the mechanical attachment of the application part to the robot arm. According to one design, the proximal connecting means is electrically conductively connectable, in particular connected, to the control unit, and/or the distal connecting means is electrically conductively connectable, in particular connected, to the application part.

According to one design, the connection of the proximal connecting means to the control unit, and/or the connection of the distal connecting means to the application part, is detachable. This is advantageous in terms of the ability to adapt the robot system to various tasks over the course of its service life.

As already explained above, in addition to the robot, the robot system also comprises an adapter, which connects the protective conductor of the cable with the grounding of the robot, or is intended or configured for this purpose. This is advantageous, because, for the first time now, an option for reconfiguring the robot back and forth between the two above-mentioned applications in an efficient manner is provided. To do this, the protective conductor of the cable is connected to the grounding of the robot, in particular short-circuited, so as to draw the protective conductor to the ground potential of the robot. This results in a closed electrical circuit between the application part and the surroundings via the grounding, as is advantageous for certain applications. According to one design, the device is grounded via a contact of the protective conductor with a grounded part of the housing of the robot, or via a separate grounding wire that, in one design, extends inside the robot arm. The latter configuration is preferred especially when large currents are expected via the grounding during normal operation, because the housing of the robot then remains de-energized, and there is no significantly increased risk of electric shock for the operator and/or the patient.

According to one design, the protective conductor is not grounded, if it is not in electrically conductive contact with the adapter. In other words, the adapterless protective conductor is not grounded. If the adapter is not electrically conductively connected to the protective conductor of the cable and the grounding of the robot, the protective conductor itself is not grounded in this design. It is at an energy level that is generally different from the ground potential and there is no significant electrically conductive connection with the ground. This means that an application part, which is not separately grounded and is connected to this protective conductor, is not grounded either. Due to insulation resistance via the ground, no significant circuit can be closed here, which is why this state is referred to as “floating”. This is advantageous, because the robot system can now be used, without major reconfiguration, in both required operating conditions: If the robot is connected to the adapter in the manner described above, an application part that is connected to the robot in this way is grounded. If the robot is operated without the adapter, the application part is operated in the floating mode described above.

According to one design, the proximal and/or the distal connecting means comprise at least one plug and/or at least one socket.

The proximal and/or the distal connecting means can comprise any desired plug and/or socket configuration or combination. Centering elements, which facilitate the insertion of a connecting means counterpiece for the application part and/or the control unit, are provided in one design. These centering elements can be provided on the connecting means and/or on the connecting means counterpiece. In another design, the connecting means and/or the connecting means counterpiece comprises an anti-twist safeguard, which largely rules out incorrect contact. In another design, the connecting means and/or the connecting means counterpiece comprise holding devices, such as barbs, to prevent inadvertent disconnection.

According to one design, the robot arm comprises a securing means to prevent unauthorized removal and/or mounting of the adapter.

Especially in the field of medical technology, there are some applications in which it is undesirable, or even life-threatening, if the application part is grounded during operation. On the other hand, however, there are cases in which it is undesirable, or even life-threatening, if the application part is not grounded. Therefore, ensuring that only authorized personnel are able to attach the adapter to or remove it from the robot is particular advantageous. Possible measures include, but are not limited to: locks for locking the adapter to the robot, special holding devices, such as special screws for mounting the adapter, which can only be unscrewed with special tools, alarm systems, emergency shutdown systems and the like.

According to one design, the robot system comprises the application part that is mounted onto the mounting device of the robot arm, in particular detachably, and is connected, in particular detachably, to the cable via the distal connecting means, wherein the adapter is disposed between the distal connecting means and the application part or is integrally disposed within the application part.

According to one design, the adapter is disposed as a separate element between the cable and the application part. This has the advantage that the adapter is available for a plurality of usable application parts and can be installed and removed as needed.

According to one design, the adapter is integrally disposed within the application part. This has the advantage that, in one design, an application part configured in this manner cannot be used ungrounded, thus enabling optimal protection against accidental ungrounded use of the application part.

According to one design, the robot system comprises the control unit for the purpose of controlling and/or reading and/or supplying power to the application part, wherein the control unit can be connected, in particular is connected, to the cable via the proximal connecting means, and wherein the adapter is disposed between the proximal connecting means and the control unit, or is integrally disposed within the control unit.

According to one design, the adapter is disposed as a separate element between the cable and the control unit. This has the advantage that the adapter is available for a plurality of usable control units and can be installed and removed as needed.

According to one design, the adapter is integrally disposed within the control unit. This has the advantage that a control unit configured in this manner cannot be used ungrounded, thus enabling optimal protection against accidental ungrounded use of the application part.

According to one design of the robot system, the at least one signal line is configured to transmit data on the basis of the IEEE 802.3 Ethernet.

This has the advantage that data can be transmitted with a large bandwidth and there are already a variety of software and hardware applications that, by default, are configured according to the Ethernet standard. The efficient, robust, and fast transfer of data between the application part and the control unit is thus ensured.

According to one design of the robot system, the at least one power supply line is configured to provide the application part with an electric voltage of up to 60 V. The transmitted electric power can be based on a DC voltage or on an AC voltage.

According to one design, a direct current or alternating current is transmitted via the at least one power supply line, or the power supply line is intended or configured for this purpose. The transmission of direct current is advantageous, because many application parts require direct current, and the corresponding rectifier in the application part, which is usually required when alternating current is transmitted, can thus be dispensed with. On the other hand, the fact that it can be produced comparatively easily by means of a conventional generator speaks for the use of alternating current, because a sinusoidal profile of the current curve is the natural result of a circular movement of the generator.

According to one design of the robot system, the cable extends at least substantially within the robot arm. According to this design, the cable may extend either partially or entirely within the robot arm.

This is advantageous, because a robot arm is provided according to this design that comprises at least one less completely or partially free-running cable, which results in a significant improvement in the safety and mobility of the robot arm. The cleaning of the robot arm, in particular in a sterile environment, such as an operating room, is facilitated as well, because cleaning is not hampered or even prevented by the cable that extends at least substantially within the robot arm. Another possible advantage of this design is that the force action of the cable on the robot arm, and consequently on the movement of the robot arm, in a force-controlled mode can be taken into consideration more simply and/or more easily.

According to one design of the robot system, the robot is electrically insulated from the application part by means of insulation, in particular by means of a plastic plate, and/or the robot is electrically insulated from the cable by means of insulation, in particular by means of a plastic plate.

As already indicated above, in some applications it is advantageous for the greatest possible insulation to be provided between the robot arm and the application part. In one design this is ensured by a plastic plate, which is disposed between the application part and the robot arm in such a way that, at least substantially, there is no current flow between the application part and the robot arm. Also, according to one design, it is advantageous to keep the cable electrically separated from the robot, because an electrical interaction between the robot and the application part is thus prevented.

According to one design, on a first side, the adapter comprises first connecting means, which are complementary to the proximal connecting means of the cable, whereby, on a second side, the adapter comprises second connecting means, which are complementary to the connecting means of the control unit, or, on a first side, the adapter comprises first connecting means, which are complementary to the connecting means of the application part, whereby, on a second side, the adapter comprises second connecting means, which are complementary to the distal connecting means of the cable.

According to one design, the proximal connecting means of the cable correspond to the connecting means of the control unit in a complementary manner, as a result of which the control unit can be connected to the cable both with and without an adapter, without the need for an additional connecting means.

According to one design, the distal connecting means of the cable correspond to the connecting means of the application part in a complementary manner, as a result of which the application part can be connected to the cable both with and without an adapter, without the need for an additional connecting means.

According to a further aspect of the present invention, the robot system described here is used, whereby the application part is a medical treatment device for treating a patient, in particular with electrical energy, and/or a medical diagnostic device, in particular for the, in particular electrical acquisition, of data relating to at least one body function of the patient.

According to a further aspect of the present invention, a method for producing the robot system described above comprises:
(a) establishment of an, in particular detachable, electrical connection between the adapter and the cable via the proximal connecting means and establishment of an, in particular detachable, electrical connection between the adapter and the control unit; or
(a′) establishment of an, in particular detachable, electrical connection between the adapter and the cable via the distal connecting means and establishment of an, in particular detachable, electrical connection between the adapter and the application part.

According to one design, a method for producing the robot system described above additionally or alternatively comprises:
(b) disconnecting an, in particular detachable, electrical connection between the adapter and the cable and in particular disconnecting an, in particular detachable, electrical connection between the adapter and the control unit; or
(b′) disconnecting an, in particular detachable, electrical connection between the adapter and the cable and in particular disconnecting an, in particular detachable, electrical connection between the adapter and the application.

According to one design the method further comprises:
(c) establishment of an, in particular detachable, electrical connection between another control unit and the cable in particular via the adapter; or
(c′) establishment of an, in particular detachable, electrical connection between another application part and the cable, in particular via the adapter.

The robot system that comprises the robot and the adapter is particularly advantageous, because, for the first time, in one design an option is provided to realize both applications with a grounded protective conductor and applications with a non-grounded protective conductor with a single robot, without major reconfiguration measures on or in the robot.

According to one design, the robot system is present in a configuration in which the components robot, application part, control unit and adapter are not connected to one another. A method for producing an above-mentioned robot system in particular comprises the following steps:
establishment of an, in particular detachable, electrical connection between the adapter and the cable via the proximal connecting means and establishment of an, in particular detachable, electrical connection between the adapter and the control unit;
establishment of an, in particular detachable, electrical adapterless connection between the cable and the application part via the distal connecting means; and
mounting the application part on the mounting device of the robot arm.

An alternative method for producing an above-mentioned robot system in particular comprises the following steps:
establishment of an, in particular detachable, adapterless electrical connection between the cable and the control unit via the proximal connecting means;
establishment of an, in particular detachable, electrical connection between the adapter and the cable via the distal connecting means and establishment of an, in particular detachable, electrical connection between the adapter and the application part; and
mounting the application part on the mounting device of the robot arm.
   According to one design, the robot system is optionally present in a configuration in which the components robot, application part, control unit and adapter are connected to one another. A method for reconfiguring the robot system in particular comprises the following steps:
disconnecting an, in particular detachable, electrical connection between the adapter and the cable and disconnecting an, in particular detachable, electrical connection between the adapter and the control unit; and
disconnecting an, in particular detachable, electrical adapterless connection between the cable and the same or another control unit via the proximal connecting means.

In the last-named method, the application part can optionally be replaced as well, with the steps:
detaching the application part from the mounting device of the robot arm; and
mounting a different application part on the mounting device of the robot arm.
   An alternative method for reconfiguring the robot system in particular comprises the following steps:
disconnecting an, in particular detachable, electrical connection between the adapter and the cable and disconnecting an, in particular detachable, electrical connection between the adapter and the application part;
detaching the application part from the mounting device of the robot arm;
establishment of an, in particular detachable, electrical adapterless connection between the cable and the same or another application part via the distal connecting means; and
mounting the same application part or the other application part on the mounting device of the robot arm.

In the last-named method, the control unit can optionally be replaced as well, with the steps:
disconnecting the, in particular detachable, electrical connection between the cable and the control unit; and
establishment of an, in particular detachable, electrical adapterless connection between the cable and the control unit via the proximal connecting means.

According to one design, the adapter of step (a) or of step (b) is integrally configured within the control unit, or the adapter according to step (a′) or according to step (b′) is integrally configured within the application part.

This has the advantage that an application part or a control unit configured in this manner can never be used ungrounded, thus enabling optimal protection against accidental ungrounded use of the application part or the control unit.

Other advantageous further developments of the present invention will become apparent from the subclaims and the following description of preferred designs. For this purpose, the figures show, in a partially schematic manner:

FIG. 1 a robot system in a partially schematic representation according to a first design of the present invention;

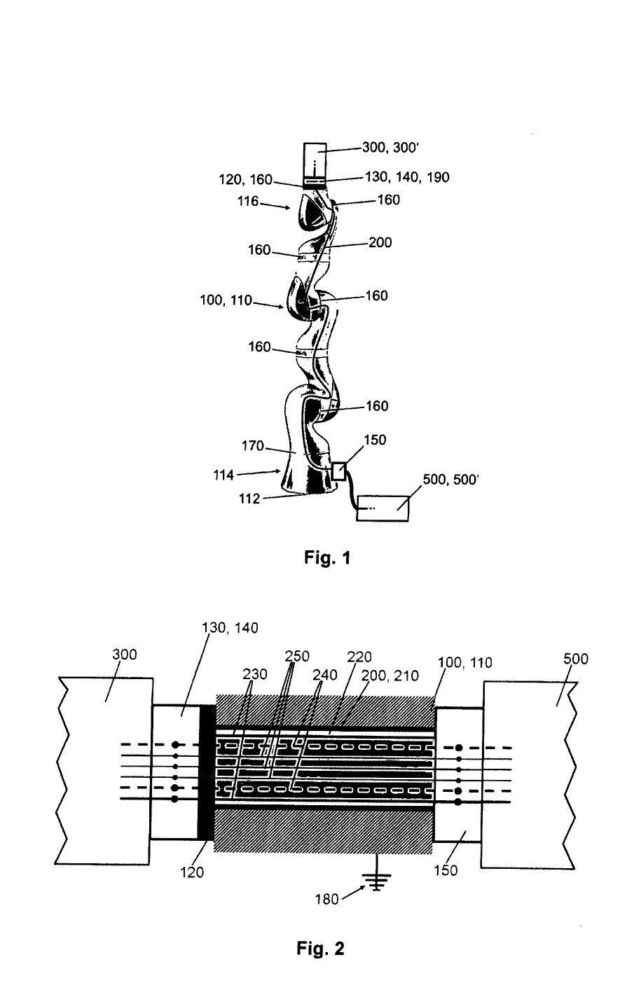

FIG. 2 a schematic view of the cable and its Interconnection according to the first design of the present invention;

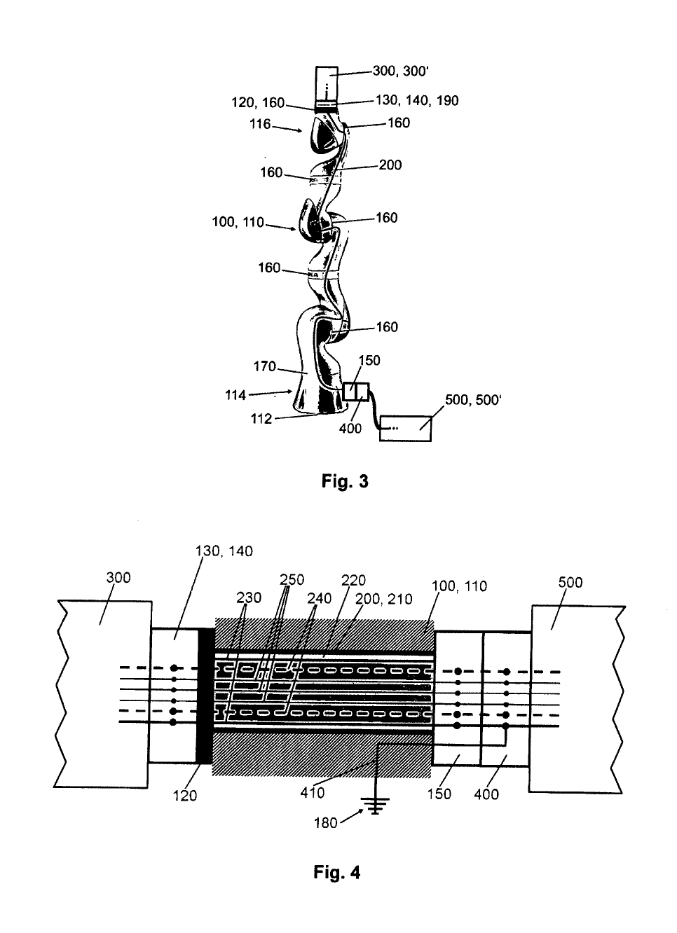

FIG. 3 a robot system in a partially schematic representation according to a second design of the present invention;

FIG. 4 a schematic view of the cable and its interconnection according to the second design of the present invention;

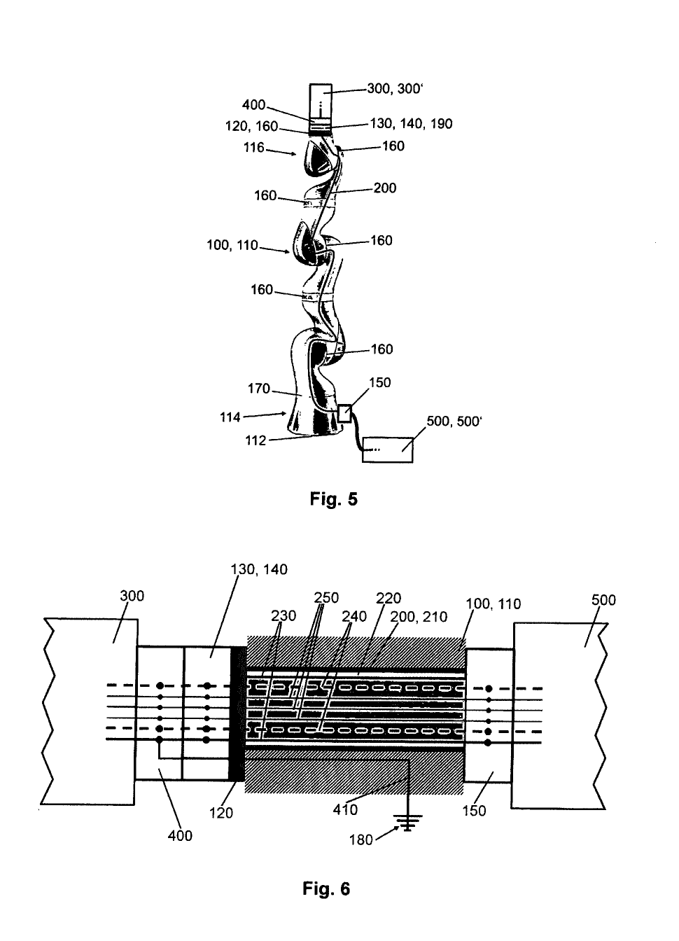

FIG. 5 a robot system in a partially schematic representation according to a third design of the present invention;

FIG. 6 a schematic view of the cable and its interconnection according to the third design of the present invention; and

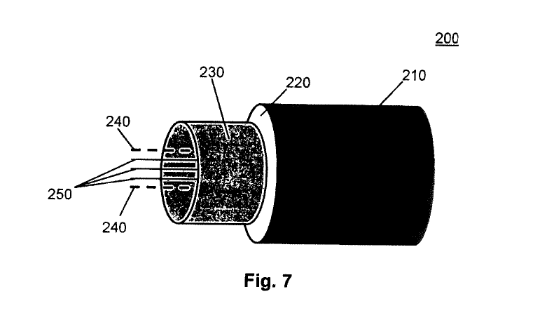

FIG. 7 a partial schematic representation of a cable for use in one of the designs of the present invention.

FIGS. 1 and 2 show a first design of a robot system of the present invention, wherein an adapter 400 is not connected to the robot 100. The robot 100 comprises a robot arm 110 in the form of a multi-axis robot arm and a robot control unit (not shown). At its base 112, the robot 100 is mounted on the floor or on a rail system (not shown). A proximal connecting means 150 for connecting a cable 200 disposed in the robot arm 110 to a control unit 500 is provided In the proximal area 114 adjacent to the base. The control unit 500 also comprises the cable, which directly or indirectly connects the control unit 500 to the robot arm 110, in particular via the adapter 400. The robot arm 110 comprises a rotation device 170 and a plurality of joints 160, which are moved in particular by means of electromotive drives (not shown). A distal area 116 opposite to the proximal area 114 comprises a mounting device 130 for mechanically attaching an application part 300, a distal connecting means 130 for electrically connecting the cable 200 to the application part 300, an insulation 120 in the form of a plastic plate and a securing means 190 for securing the application part 300 against an unauthorized removal or mounting of the application part 300.

The cable 200, which is shown in detail in FIG. 7, comprises a plurality of signal lines 250 and a plurality of power supply lines 240, which in particular respectively have their own separate insulation (not shown) from the other lines. The lines 240, 250 are surrounded by a protective conductor 230, which shields said lines from electromagnetic interference, as is produced by the electric motors inside the robot arm, for example. The protective conductor 230 can be configured in the form of a metal or metal alloy containing film and/or a metal or metal alloy containing wire mesh. To protect against a direct electrical energy transfer between the robot arm 110 and the cable 200, the latter additionally comprises an insulation layer 220 that surrounds the protective conductor. For protection against environmental influences such as temperature and/or humidity, the cable 200 furthermore comprises a cable sheath 210, which is provided around the insulation layer 220. The insulation layer 220 and the cable sheath 210 are preferably made of plastic, in particular thermoplastic material. In one design, the tasks of the cable sheath 210 and the insulation layer are taken over by one common layer (not shown).

The robot 100, i.e. the robot arm 110, comprises a grounding 180. This grounding can be configured in the form of an electrically conductive connection of the robot housing with the ground, or as a separate grounded line that is, in particular at least substantially, disposed in the interior of the robot arm 110.

The cable 200 extends entirely inside the robot arm 110. The distal connecting means 140 is electrically connected at the distal end of the cable 200, and the proximal connecting means 150 is electrically connected at the proximal end of the cable 200. When creating the connection, it is ensured that no electrically conductive connection is produced between the robot 100 and the cable 200.

The cable 200 is connected to the control unit 500 via the proximal connecting means 150. The cable 200 is connected to the application part 300 via the distal connecting means 140. Due to the protective conductor or the shielding 230, which, according to the first design, is connected to the application part 300 via the distal connecting means 140 and is connected to the control unit 500 via the proximal connecting means 150, but is not connected to the grounding 180, the protective conductor is not at the potential of the grounding 180, so that the robot system is being operated in the so-called floating mode.

The second design according to FIGS. 3 and 4 differs structurally from the first design mainly in that the adapter 400 is electrically conductively interposed between the proximal connecting means 150 and the control unit 500. Unless something else results from the text of the following paragraph or the knowledge of the person skilled in the art, all statements made above regarding the first design are also applicable to the second design.

The cable 200 is connected to the control unit 500 via the proximal connecting means 140 and the adapter 400. Due to the protective conductor or the shielding 230, which, according to the second design, is connected to the application part 300 via the distal connecting means 140 and is connected to the control unit 500 via the proximal application means 150 and is connected to the grounding 180 via the adapter 400 and the robot arm 110, the protective conductor is at the potential of the grounding 180, so that the application part is being operated in the so-called grounded mode. The adapter 400 can in particular be configured as an integral component of the control unit 500, and disposed either in a connecting means counterpiece of the control unit 500 complementary to the proximal connecting means 150 or in the control unit 500 itself.

The third design according to FIGS. 5 and 6 differs structurally from the first design mainly in that the adapter 400 is electrically conductively interposed between the distal connecting means 140 and the application part 300. Unless something else results from the text of the following paragraph or the knowledge of the person skilled in the art, all statements made above regarding the first design are also applicable to the third design.

The cable 200 is connected to the application part 300 via the distal connecting means 140 and the adapter 400. Due to the protective conductor or the shielding 230, which, according to the third design, is connected to the application part 300 via the distal connecting means 140 and is connected to the control unit 500 via the proximal application means 150 and is connected to the grounding 180 via the adapter 400 and the robot arm 110, the protective conductor is at the potential of the grounding 180, so that the application part is being operated in the so-called grounded mode. The adapter 400 can in particular be configured as an integral component of the application part 300, and disposed either in a connecting means counterpiece of the application part 300 complementary to the distal connecting means 140 or in the application part 300 itself.

Even though exemplary designs have been discussed in the foregoing description, it should be noted that a variety of modifications are possible. It should also be noted that the exemplary designs are simply examples, which should not in any way limit the scope of protection, the applications, and the structure. Rather, the preceding description provides the person skilled in the art with a guide for implementing at least one exemplary design, whereby various changes, in particular with regard to the function and arrangement of the described components, can be made without leaving the scope of protection as it emerges from the claims and feature combinations equivalent to said claims.

### LIST OF REFERENCE SIGNS

### 100 Robot

### 110 Robot arm

### 112 Base

114 Proximal area of the robot arm
116 Distal area of the robot arm

### 120 Insulation

130 Mounting device
140 Distal connecting means
150 Proximal connecting means

### 160 Joint

170 Rotation device

### 180 Grounding

190 Securing means

### 200 Cable

210 Cable sheath
220 Insulation layer
230 Protective conductor or shielding
240 Power supply line
250 Signal line
300 Application part

### 400 Adapter

410 Electrical line
500 Control unit for the application part

1. Robot system with:
(I) a robot (100) for guiding an application part (300), wherein said robot (100) comprises:
(a) a robot arm (110) with
a base (112);
an area (114) that is proximal to the base (112);
an area (116) that is distal to the base (112); and a mounting device (130) for the, in particular detachable, mounting of the application part (300), wherein the mounting device (130) is disposed in the distal area (116);
(b) a grounding (180); and
(c) a cable (200) for the, in particular detachable, connection to the application part (300) and a control unit (500), with
at least one signal line (250) and/or at least one power supply line (240);
a protective conductor (230);
a distal connecting means (140) for the electrical, in particular detachable, connection of the application part (300) to the cable (200); and
a proximal connecting means (150) for the electrical, in particular detachable, connection of the control unit (500) to the cable (200); and
(II) an adapter (400), comprising an electrical line (410) for the electrical, in particular detachable, connection of the protective conductor (230) of the cable (200) to the grounding (180) of the robot (100).

2-16. (canceled)
